(19) United States
(12) Patent Application Publication
(10) Pub. No.: US 2006/0015365 A1
(43) Pub. Date: Jan. 19, 2006

(54) Retail system and method

(76) Inventor: Charles Stofko, Sandy Hook, CT (US)

Correspondence Address: Thomas J. Monahan, Esq.;Monahan & Costello, LLC, 4154 Madison Avenue, Trumbull, CT, 06611, US

(21) Appl. No.: 11/173,426

(22) Filed: Jul. 1, 2005

Related U.S. Application Data
(60) Provisional application No. 60/587,768, filed on Jul. 15, 2004.

(51) Int. Cl. G06Q 99/00

(52) U.S. Cl. 705/1; 705/26

(57) ABSTRACT

There is provided a retail shopping system and method. The retail shopping system is preferably a grocery retailing system or supermarket. The system comprises a franchiser and at least two distinct-class retail merchant operator franchisees that are retail merchant operators of any combination of perishable goods, retail merchant operators of non-perishable goods, and retail merchant operators of service trades. Optionally, the franchisor may provide a variety of specialized support goods and services to the member franchisees.

This application clams priority from U.S. Provisional Application No. 60/587,768 filed Jul. 15, 2004.

### BACKGROUND OF THE INVENTION

1. Field of the Invention

The present invention relates to commercial systems and methods. More particularly, the present invention relates to retail systems and methods for the supermarket and related industries.

2. Description of the Prior Art

By way of background, the grocery retailing industry in the U.S. has undergone significant changes in recent years in response to competitive factors the Industry calls, The Fragmented Grocery Channels (Wal-Mart, Warehouse Clubs, Dollar Stores, Convenience Stores and Drugstores).

The fragmenting of traditional grocery retail channels in recent years has created a hypercompetitive marketplace threatening the survival of many supermarket companies. In his book “Hypercompetition; Managing the Dynamics of Strategic Maneuvering,” Richard D'Aveni describes Hypercompetition as a competitive environment where sustainable advantages are temporary and are becoming more temporary every day: “Hypercompetition forces companies to go through the agonizing process of reinventing themselves, developing new advantages, undermining the advantages of their competitors, and increasing the intensity of competition. At their peak in the late 1980's the Supermarket Industry (SMI) controlled approximately 90% of the grocery and consumables market. Since then many Supermarket Companies (SMC) have lost their traditional competitive advantage and have been losing significant market share of the retail grocery business at an alarming rate. In 2004, the SMI's market share of groceries and consumables was approximately 56% and is continuing to shrink. Additionally, as a result of continuing loss of market share, the Food Marketing Institute reported the results of a survey that showed supermarket profitability declining in a twelve month period (the last half of 2003 and the first half of 2004) from 0.95% to 0.88%, as a percentage of sales.

Some SMC, aware of their eroding market share and the competition's ability to drive down costs, have made tactical responses. Such tactical responses tend to imitate Wal-mart's focus on driving out the costs in their system. For example, Albertson's saw their earnings drop 20% in 2004 from 2003 levels. In response, Albertson's affected a three year $1 billion cost cutting program in 2004 and just recently announced a new $250 million two year additional cost cutting program that will attempt to reduce administrative expenses and expand centralized, chain-wide purchasing. Such tactical responses may have some short-term financial benefit, but certainly do not represent a strategic change in business practices that would produce long-term lasting benefits. When faced with such competition, it is not unreasonable to suggest that SMI's should not be simply looking a ways to cut operating costs and save money, but should be looking at strategic responses. For example, a possible strategy might be to somehow create a compelling customer shopping experience that would provide a clearly differentiated shopping experience in contrast to the competition. Such strategy would build a distinct connection with customers, build customer loyalty and provide a future vision of the supermarket industry.

Several supermarkets, including Safeway, Kroger and Albertsons, have made public statements that relate to improving their competitive position in the marketplace. These objectives typically relate to various ways to better brand the shopping experience, including improving perishables, being more competitive on prices, cutting operating and labor costs, improving service and being more aggressive with marketing. While such statements are well intentioned and certainly reasonable business objectives, it is questionable whether such initiatives will be implemented effectively or whether in fact they would markedly improve the competitive position of supermarkets if implemented. The situation is more complicated than such cost cutting and product improvements would indicate. Supermarkets are not planning to convert their businesses to making money on the sale rather than on the buy as is currently practiced. Traditional supermarkets are all too frequently focusing on supporting their current business model (product) rather than on the consumer. The supermarkets are basically continuing to operate as they have for decades with minor modifications. However, the world has changed, the competitive environment has changed, and customers have changed. It is reasonable to suggest that the current grocery retail model utilized by the supermarkets should also change and by doing so make appropriate adaptation to current market conditions. When any industry is not attuned to the changing need and concern of its customers and management fails to react to the realities of a changing competitive environment, the very survival of that industry is brought into question. The supermarket industry is currently in this position.

Supermarkets have created various programs that put pressure on product manufacturers and limit the ability of supermarkets to respond to competitive pressures in the marketplace. Such programs include slotting allowances, BOGOs (Buy One Get One Free), and the like. In general, manufacturers are forced to participate in these programs in order to keep supermarket business. This creates a great and constant tension between the vendor community and the supermarkets. These programs increase the costs of the manufactures and ultimately decrease their profits. However, the programs (i.e., slotting allowances) create fees that provide profit centers for the supermarkets. The fees that supermarkets derive from these programs bolster the status quo and constrain supermarkets from changing their current business practices. Supermarkets continue to make money on the “buy” (i.e., slotting fees, BOGOs/program allowances; and advertisement fees) rather than the “sell” and thereby concentrate on their traditional business model (product) rather than the customer. Traditional supermarkets have enjoyed monopolistic control of the grocery and consumables business until the late 1980s. This position of monopoly encouraged very little consideration of customers. The supermarkets are currently out of touch with their customers and certainly are not meeting the needs of their customers. The disjoint with customers is evidenced by the continually shrinking market share of the major supermarkets. Would supermarkets continue to survive if their market share drops to ˜40% or lower from their current 56% of the grocery and consumables business? The survival of supermarkets as currently structured is questionable, especially as they continue to rely on programs which distract them from focusing on the needs of their customers. With the absolute power that any monopoly brings, there is a tendency not only to disregard customers, but also to regard employees as accounting costs rather than assets. It should be noted that there are some supermarkets (i.e., Wegmans, Publix, HEB) that do properly regard their employees as assets rather than liabilities, but that is not the policy for most large supermarkets.

In summary, during the evolution of the present-day supermarket their first value-proposition was the retail synergies of convenience and good service. When competition compelled supermarkets to add low-price to their value-proposition, good service eventually suffered. However supermarkets were able to sustain monopolistic control of their Industry until the late 1980's. That is when the grocery and consumables business became hypercompetitive. As customer focused businesses, Wal-Mart and the fragmented grocery channels began to beat the supermarkets on price and meet or exceed supermarket service levels. Having lost their competitive advantage, supermarkets are now losing market share at an alarming rate.

In response to decreased market share, one of the SMI's tactical responses was the “Store within a Store” concept. The “Store within a Store” concept involves leasing agreements whereby the success of the “Store within a Store” operates independently of their Landlord. This retail model is similar to the current department store mall retail format. The rational for both scenarios is an attempt to create the retail synergies of convenience. However the retail synergies of convenience are not a sustainable competitive advantage (i.e., when synergies of convenience exist in the marketplace and competitors are able to offer the same of similar synergies of convenience, the competitive advantage is not sustained). There is clearly a need for a new supermarket retail formula. The RMOs of the present invention are interdependently operated within the system of the invention rather than independent of each other.

Accordingly, it is an object of the present invention to provide a system for retail businesses.

Another object of the present invention is to provide a system for retail grocery retailing.

Another object of the present invention is to provide a new and improved method for the operation of retail businesses.

Yet another object of the present invention is to provide a new and improved method for operation of grocery retailing.

A further object of the present invention is to provide a new and improved supermarket method and system.

### SUMMARY OF THE INVENTION

The present invention provides a retail shopping system that comprises a franchiser and at least two distinct-class retail merchant operator member franchisees. The franchisees are selected from retail merchant operators of perishable goods, retail merchant operators of non-perishable goods, and retail merchant operators of service trades. The franchiser and the franchisees are preferably co-located in a common building. A particularly preferred embodiment of the invention is a grocery retail system or supermarket.

A wide variety of retail merchant operator franchisees may be used in the system of the invention, including, but not limited to, selections from the following groups: a fresh produce grocery member; a bakery member; a meat/butcher member; a fish & shellfish member; a dairy member; a non-perishable grocery member; an alcoholic beverage member; a food service member; a food specialties member; a service trades member; a florist member; a health and beauty aid member; a food catering member; a prepared food service member; an office supply outlet member; a drugstore member; a clothing store member; a sports specialties member; a hardware member; a drycleaner member; a bookseller member; a card seller member; an electronics member; a home furnishings member; an art gallery member; a photography member; a music member; a toys and hobbies member; a shoe member; a restaurant member; a fast food member; a tailor member; an eyeglass member; a dentist member; a physician member; a chiropractor member; a lawyer member; a market research member; an accountant member; a bank member; a plumbing supply member; a pawnshop member; a tattoo parlor member; an auto parts supply member; a therapeutic massage member; a health club member; a post office member; a building supply member; a plumber member; an electrician member; a garden supply and equipment member; a podiatrist member; a food specialties member and any combinations thereof.

A clothing store member may be selected from the group of men's fashions; women's fashions; and children's fashions, and any combinations thereof. A food specialties member may be selected from the group of a coffee member; a pretzel member; an ice cream member; a yogurt member; a cookie member, and any combinations thereof. A shoe member may be selected from the group of men's shoes member, women's shoes member; children's shoes member, sports shoes, and any combinations thereof. A service trades member may be selected from the group of shoe repair member, portrait studio member, jewelry repair member, bank member, optician member, travel bureau member, custom decorating member, and any combinations thereof. A food service member may be selected from the group of: a delicatessen member; a donut and bagel member; an ice cream and yogurt member; a Mexican, Japanese or other ethnic fast-food member; a sub and sandwich member; a non-alcoholic beverage member; and any combinations thereof.

In the system of the invention, the franchiser provides property rights to the franchisee. These property rights include, but are not limited to, patents, trademarks, copyrights, know-how, trade secrets, leases, branding and any combinations thereof. Also, the franchiser may optionally provide at least one of the following services: advertising, culture of legendary customer service standards training, operational & ready-for-business standards training, equipment standards training, front-end operations, RMO financial projections and sales goals services, merchant member business services, business support programs, internet data bases and marketing services, banking services, payroll services, employee health and medical benefits services, Next Generation (i.e., comprising the system and method of the invention) supermarket training services, and Next Generation market branding services.

The invention provides a method for developing a retail shopping system. The method comprises selecting or constructing a retail building; designing and constructing or modifying/renovating the retail building to accommodate a plurality of retail merchant operator franchisees and a franchiser; selecting at least two distinct-class retail merchant operators; forming a franchise arrangement between said retail merchant operators and said franchisor; and entering retail shopping activities. The retail merchant operators are selected from the group consisting of retail merchant operators of perishable goods, retail merchant operators of non-perishable goods, and retail merchant operators of services trades, and any combinations thereof.

More specifically, retail merchant operators of the method of the invention are selected from the group consisting of: fresh produce grocery members; bakery members; meat/butcher members; fish & shellfish members; dairy products member; non-perishable grocery members; alcoholic beverage members; food service members; food specialties members; service trades members; florist members; health and beauty aid members; food catering members; prepared food service members; office supply outlet members; a drugstore members; clothing store member; sports specialties members; hardware members; plumbing supply members; drycleaner members; bookseller members; card seller members; electronics members; home furnishings members; art gallery members; photography members; music supplies members; toys and hobbies members; shoe members; restaurant members; fast food members; tailor members; eyeglass members; dentist members; physician members; chiropractor members; attorney members; market research members; accountant members; bank members; plumbing supply members; pawnshop members; tattoo parlor members; auto parts supply members; therapeutic massage members; health club members; post office members; building supply members; plumber members; electrician members; garden supply and equipment members; podiatrist members; food specialties members and any combinations thereof.

For example, clothing store member(s) of the method of the invention may conveniently be retail stores providing men's fashions; women's fashions; or children's fashions, and any combinations thereof. Food specialties member may, for example, be selected from the group of a coffee shop members; pretzel shop members; ice cream shop members; yogurt shop members; specialty cookie shop members, and any combinations thereof. In addition, shoe shop members may be selected from the group of: men's shoes member, women's shoes member, children's shoes member, sports shoes member; and any combinations thereof. Also, service trades member may be selected from the group of: shoe repair member; portrait studio member; jewelry repair member; bank member; optician member; travel bureau member; custom decorating member, and any combinations thereof. Food service members may be conveniently chosen from the group of: delicatessen shop members; donut and bagel shop members; an ice cream and yogurt shop members; Mexican, Japanese or other ethnic fast-food members; sub/hogie/grinder and sandwich members; non-alcoholic beverage members; and any combinations thereof.

In the system and method of the invention, the franchiser provides property rights to the franchisees including, but no limited to, patents, trademarks, copyrights, know-how, trade secrets, leases, branding and any combinations thereof.

Also, the franchiser of the method of the invention may optionally provide at least one services selected from the group of advertising, culture of legendary customer service standards training, operational & ready for business standards training, equipment standards training, front-end operations, RMO financial projections and sales goals services, merchant member business services, business support programs, internet data bases and marketing services, banking services, payroll services, employee health and medical benefits services, Next Generation supermarket training services, and Next Generation market branding services, and any combination thereof.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, the preferred methods and materials are described. All publications, patent applications, patent and any other references mentioned herein are incorporated by reference in their entirety. In case of conflict, the present specification, including definitions, will control. In addition, the materials, methods and examples are illustrative only and not intended to be limiting.

Other features and advantages of the invention will be apparent from the following detailed description and from the claims.

### BRIEF DESCRIPTION OF THE DRAWINGS

FIG. 1 is a schematic drawing of a franchisor/franchisee relationship of the system of the invention.

FIG. 2 is a schematic drawing of RMO business support systems provided by the franchisor of the invention.

FIG. 3 is a schematic drawing of certain selected RMOs of the invention.

FIG. 4 is a schematic drawing of a supermarket embodiment of the invention.

FIG. 5 is a schematic drawing of a supermarket embodiment of the invention with selected branded franchisees.

### DETAILED DESCRIPTION OF THE INVENTION

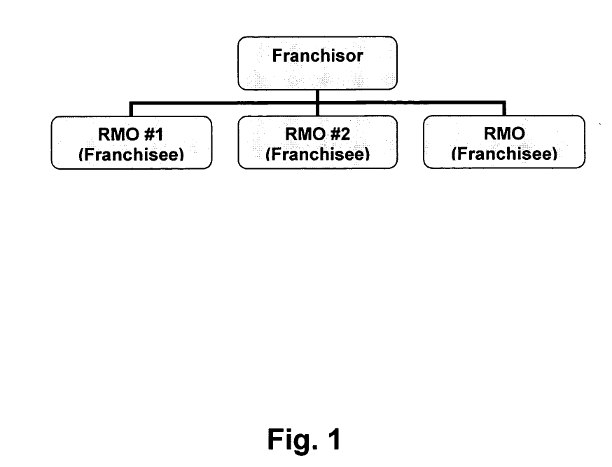

The present invention is directed to systems and methods of retail businesses, including but not limited to grocery retailing. Referring now to FIG. 1, there is shown a schematic representation of a franchiser of the invention with Retail Member Operators (RMOs). Shown are only three RMOs, but the invention provides a plurality of RMOs which may be variable.

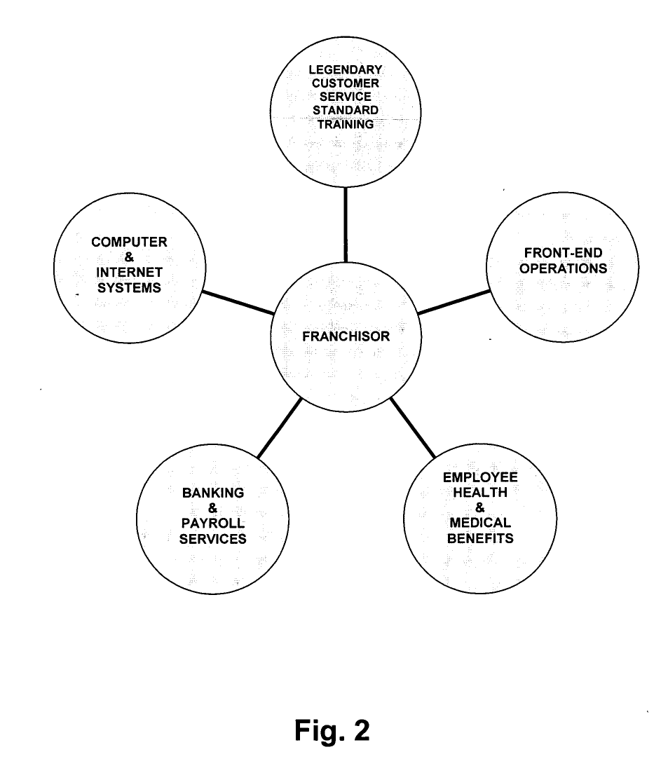

Referring to FIG. 2, shown is a schematic representation of several RMO Business Support services or system that may be provided by the franchisor of the invention.

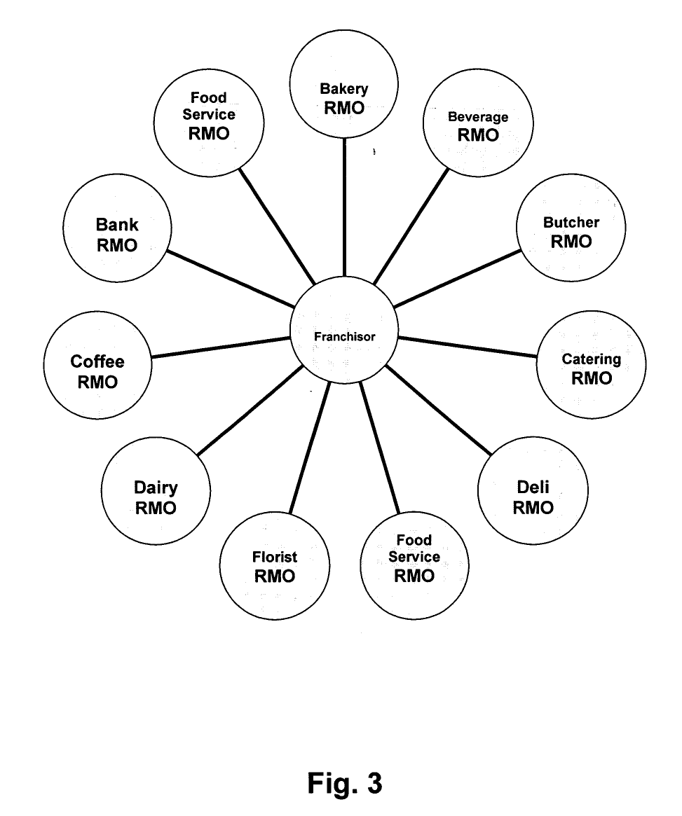

Referring to FIG. 3, shown is a selection of several representative RMOs as Franchisees in the system of the invention.

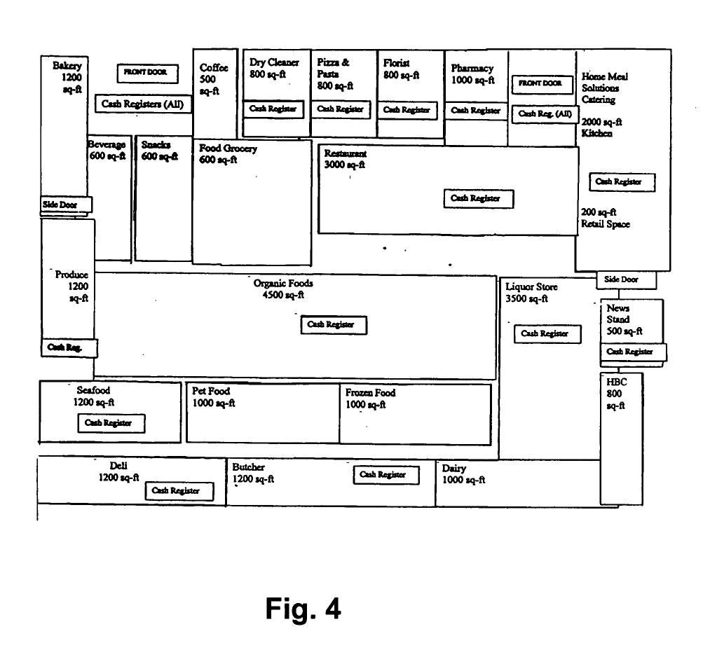

Referring to FIG. 4, shown is an example of the layout of a representative supermarket embodiment of the invention. Shown are locations of selected RMO franchisees relative to each other together with approximate space requirements for each RMO. The selection of RMO, the location and size of the RMOs may vary. Customer convenience, customers product/service requirements, and complimentary or synergistic products or services are considerations involved in building design, RMO sizing, and RMO placement.

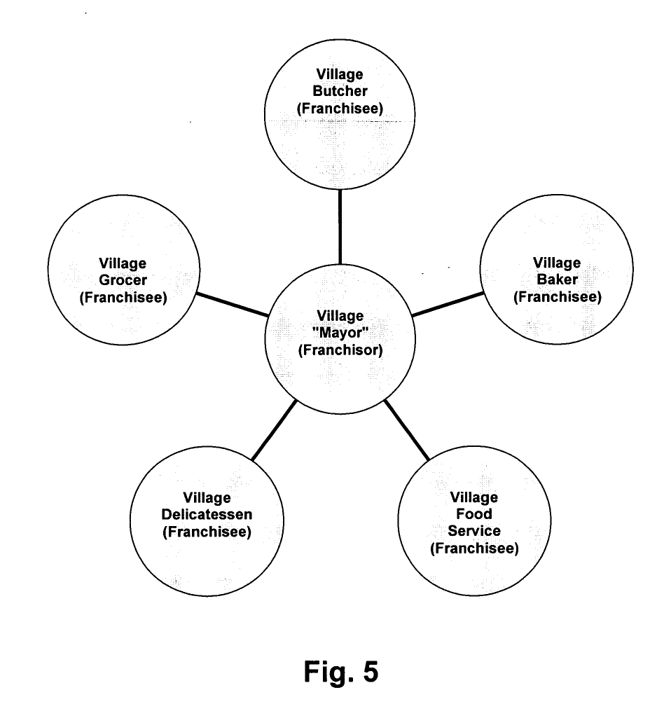

Referring to FIG. 5, shown is an example of selected branded franchisees. In this schematic, the franchisor of the invention is referred to a the “Mayor” of a “Village” (the Next Generation Supermarket of the invention) and there are several branded franchise RMO that are resident enterprises of the Village.

In the present invention several words and phrases are used that require definition. A “Retail Member Operator” (RMO) is an enterprise that sells goods and services to the retail-public within an Intelligent Shopping Destination. RMO's will be independent operators. Each Retail-Merchant's business domain and business standards will be defined and managed with Franchise agreements. The term “Retail Intelligence” is the process of intelligently facilitating a collection of strategically organized Retail Member Operators. An “Intelligent Shopping Destination” is created when Retail Intelligence is practiced. “Speed of Life” is defined as the daily pace customers set for themselves as they try to accomplish the jobs, tasks or chores deemed necessary to enjoy the life they have designed or to which they aspire. A “Culture of Legendary Customer Services”, is created and becomes a brand when the consumer-focused franchisor/franchisee, village-market-like, main-street-like system of the invention can develop.

Symbiotic Retailing Relationships. “Symbiotic Retailing Relationships” are the interdependent and mutually beneficial relationships shared among Retail Member Operators. “Symbiotic Retailing Relations” is a phrase that represents an attempt to encourage and create synergistic business relationships (Business Synergies). A Symbiotic Retailing Relationship can be illustrated as follows: Food Service Operations (FSO) will produce fresh value added Home Meal Solutions (HMS) for Retail Member Operators. Onsite production of HMS will keep retail costs down by eliminating transportation and other production costs associated with consumer packaged goods. The prices for fresh product will be in line with comparable frozen or shelf stable value added products creating value. For example: FSO will provide the Meat and Seafood Merchants with fresh value added HMS. One scenario will have the FSO purchase the Meat and Seafood ingredients at a wholesale cost from the Meat and Seafood Retail Member Operators and then sell the finished product to the Meat and Seafood Retail Member Operators at a wholesale cost. Countless Symbiotic Retailing Relation scenarios will emerge en route to creating Business Synergies and operating efficiencies.

Carving-into. The phrase “Carving-into” relates to a retail space capable of housing “The Next Generation Supermarket” designed to accommodate the food service and retail space requirements of Retail Member Operators. RMO space requirements will then be “carved-into” the building.

The Lease-Gap. The “Lease-Gap Profit Center” in the present invention refers to financial benefits from leasing arrangements. For example, it is known that the price per square-foot for a large retail space (20,000 sq-ft or more) will vary based on the demographics of a town and that corresponding small retail space (2,000 sq-ft or less) will follow the same variables. For example a 50,000 ft²+retail space will cost $10 per sq-ft annually and a 2,000 ft² or less will cost $30 per sq-ft annually. Retail Member Operators will benefit from the traffic of an intelligent shopping destination and will pay the fair market price for a small retail space. The difference in price is what we refer to as the “Lease-Gap” and will be one of the profit centers of the invention.

Next Generation Retail Business System. The present invention provides a new retail system and method. While a preferred application is food or grocery retailing, the invention is broadly applicable to a variety of retail systems. The present invention provides a new and improved supermarket method and system that fundamentally shifts the strategic focus of merchants conducting grocery retailing businesses. This system and method is capable of succeeding in the hyper competitive food-retailing market place and any other retail marketplace. It facilitates the union of best-in-class market niche and specialty food and other retailers, and creates a unique and intelligent shopping experience designed for customer speed and convenience. A Next Generation Retail Business System of the invention may have RMOs from any retail business that can be conveniently co-located with other RMOs in a centralized facility. RMOs of Next Generation Retail Business systems and Next Generation Supermarket systems may comprise at least two, preferably more, retail businesses that provide either perishable or non-perishable goods or services or may include any combination of perishable or non-perishable goods or services, any combination of perishable goods and/or services, and any combination of non-perishable goods and/or services. Perishable retail business RMOs include, but are not limited to, individual or combinations of the following members: bakery, beverage, butcher, catering, coffee shop, vitamin and nutriceutical , dairy member, delicatessen member, food service member (i.e, hot meals etc.), florist member, frozen food member, ice cream member, bagel member, grocery member, pizza & fresh pasta member, produce member, and seafood member. Non-perishable RMOs include, but are not limited to, individual or combinations of the following members: bank, health & beauty care, office supply, hardware, clothing, sports equipment, shoe, jewelry, photography, and clothing cleaner. In the case of Next Generation Retail Business Systems, it is preferred that RMOs primarily provide non-perishable goods or services, with a lesser amount, if any, of perishable goods. In the case of Next Generation Supermarket systems, it is preferred that RMOs primarily provide grocer and perishable goods with a lesser amount, if any, of non-perishable goods and/or services.

Next Generation Supermarket. A central part of the present invention involves a central management business enterprise (the “Company”). A preferred embodiment of the invention is a retail supermarket system. The Company will be required to implement and manage the Next Generation Supermarket system. The Company will first acquire and begin design and management of an existing or newly constructed retail space. The space requirements are generally from <or =5,000 ft² to >30,000 ft². The Company will practice Retail Intelligence. The practice of Retail Intelligence is simply the process of intelligently facilitating the union of a group of Retail-Merchants in a single location as the means of creating an Intelligent Shopping Destination. This destination will provide customers the convenience of access to a group of Retail-Merchants that will collectively offer the same portfolio of products and services found in a traditional Super Market. The Next Generation Supermarket system of the present invention will make a strategic shift from present supermarket systems and thereby provide a significant competitive advantage to the Company and its RMOs.

The Next Generation Supermarket system of the present invention will shift traditional food retailers profit focus from net sales profit contributions to (i) real estate development (i.e., lease-gap profit contributions) and (ii) gross sales profit contributions (i.e., franchise royalty fees). This strategic shift is accomplished by the following steps (i) identifying strategically qualified retail locations and real property facilities (the “Building”), (ii) identifying strategically qualified Retail Member Operators (RMOs), (iii) the Company will enter into franchise agreements with the RMOs, (iv) the Company will encourage Symbiotic Retailing Relationships; and (v) designing the space requirements of RMOs (i.e, food service and other retailers) and thereafter the RMO space requirements will be carved-into the Building.

The present invention provides a system and method that will create a village-like or main-street-USA shopping experience with unprecedented convenience and time efficiency.

Assembly Steps. The system of the present invention is constructed in steps or phases. In phase I appropriate retail locations and real property facilities (the “Building”) will be identified and qualified by the Company as suitable for a Next Generation Retail Business. The Company will then design the Building space appropriately for the RMO members of a Next Generation Retail Business or Next Generation Supermarket. Alternatively, the RMO members may be identified first and thereafter a Building may be identified. The RMO member facilities of the Building may be arranged in any convenient fashion. However, it is preferred that certain RMOs that have retail synergies be co-located or be in proximity to one another. For example, it is preferred in a Next Generation Supermarket that certain RMO providing perishable products (i.e., fresh produce products, fish, meat etc.) be adjacent or near each other. Also, certain non-perishable RMOs (i.e., health and beauty aids, book sellers, etc.) may be conveniently adjacent or near each other. The facilities, space and other design features will consider the convenience of the customers. In general, the present system and method of the invention provide a village-like environment. In an analogy, the Company/Franchisor could be regarded as the “Village Mayor” providing overall management of the Building, including provision of essential utilities, general maintenance services, any specialized goods or services required for the operation of the Building or the RMOs. One objective of the method and system of the invention is to provide a convenient, one-stop shopping experience for consumers where they are able to obtain quality retail goods and services without having to make multiple time-consuming shopping trips and stops throughout the community. Thus, consumers are able to access key goods and services of a “village” without having to travel throughout the “village”.

RMOs. Next, appropriate RMOs having high quality standards will be identified and qualified by the Company. Suitable candidates for RMOs in a supermarket embodiment, include, but are not limited to at least two, and preferably more, of the following retail business members: bakery member; bank member, beverage member, butcher member, catering member, coffee shop member, dairy Member, delicatessen member, food service member, florist member, frozen food member, grocery member, health & beauty care member, office supply member, pizza & fresh pasta member, produce member, and seafood member. The Company will explain the preferred RMO operational specifications to prospective RMOs and negotiate related issues with the RMOs. The RMOs would preferably be selected from local specialty businesses in proximity to reasonable commuting distance to the Building who desire to expand their business operation and to work as a franchisee under the selected brand name of the Franchisor. The RMOs selected would preferably have a community reputation for high quality products or services.

The Franchise. A chosen RMO will be required to enter into a formal franchise agreement with the Company. The Company has certain intellectual property rights that would be conveyed to RMOs as part of a franchise agreement. Such intellectual property rights may include patents, trademarks, copyrights and know-how and trade secrets. As a significant component of the system of the invention, the Company would have a distinct brand for its Next Generation Supermarkets or Next Generation Retail Business Systems. The names Next Generation Supermarket and Next Generation Retail Business Systems are meant to designate the system of the invention and not to necessary represent any brand. The brand for the system and method of the invention can be any convenient brand. For example the brand of Company/Franchisor may be “The Village”; the brands provided to the various franchisees may be “The Village Baker”, “The Village Grocer”, “The Village Baker”, “The Village Food Service”, “The Village Butcher”, etc. as illustrated in FIG. 5. The Company would preferably license or otherwise provide in its franchise agreements with RMOs a single brand. However, a plurality of different brands may optionally be provided involving RMOs in a Building. A secondary franchise may optionally be provided (i.e, a franchise of an existing franchise).

The system and method of the invention for the retail distribution of goods and services involves franchising. As used herein, the term Franchisor refers to the legal owner of certain business concepts and ideas who holds the right to grant others a license to use the franchised business concepts and ideas. The term Franchisee is an individual or entity that purchases the license right to use the franchised business concept and ideas. The Franchisee purchases the right to run a business typically involving a limited term license according to the specified terms and conditions determined by the Franchisor. The system and method of the invention is well suited for franchising. It is possible to duplicate the system and method of the invention in many different locations. The invention does not depend on a totally unique location or specific personality in order to function. Franchising provides various benefits to the parties (i.e., shared or reduced advertising costs, etc.), including the retail synergies that the brining together of a collection of retailers of the invention provides. While the franchise relationship of the invention will convey proprietary common property rights to the system and method, including branding, to franchisees, at least two of the franchisees are selected from distinct classes of retail merchants (i.e., perishable grocery outlet, food service member, florist member etc.). In a preferred embodiment, when there are more than two RMOs where at least two of the RMOs are from distinct classes of retail merchants, there may optionally be more than one RMO from any given distinct class of retain merchants. For example, there may be two florists each of which is run by a separate franchisee in a common building where there is also a variety of other distinct-class RMOs (i.e., a perishable grocery products member, a delicatessen member, a dairy member, a bakery member, a catering member, etc.). However, it is preferred that there only be one RMO from any given distinct class of retail merchants.

Franchisor Considertion. The Company/RMO franchise agreement includes, but is not necessarily limited to a lease agreement and license to intellectual property rights, and at least one of the following: royalty agreement, legendary customer service standards, operational & ready for business standards, equipment standards, retail transaction & product domain agreements, symbiotic business relations (i.e., mutually complementary businesses such as a health and beauty aids RMO near a drugstore RMO), anchor RMO agreements, front-end Operations, RMO financial projections and sales goals, merchant member business services & business support programs, internet data bases and marketing services, banking services, payroll services, employee health and medical benefits, Next Generation supermarket training, and Next Generation market branding.

For the system of the invention, a Building with appropriate space and facilities for RMO franchisees is required. Construction plans for the customization of RMO locations in the Building must be designed together with the preparation of price estimates. Once the plans for the customization of the building containing the RMOs is completed, construction can begin.

RMO franchisees are located in the Building in any desired pattern. The Franchisor or its designee may be co-located with the RMOs in the Building, but may also be geographically separated from the RMOs in the Building. In a preferred embodiment, the Franchisor or its designee or agent is co-located with the RMOs. However, the Franchisor in either event must comply with the obligations of its franchise agreements with RMOs (i.e., to supply various facilities and services).

Following design, planning, construction, and occupation of the Building with RMOs of the Next Generation Supermarket or Next Generation Retail Business System, The Franchisor implements RMO Business Support Systems. The Business Support Systems are selected from, but are not limited to, the following: Legendary Customer Support Standard Training, Front-End Operations, Computer and internet systems, and Employee Health and Medical Benefits. However, the RMO Franchisees are each responsible for their own employees. The Next Generation Supermarket or Next Generation Retail Business System commence operation with physical facilities and required services provided by Franchisor in place. Marketing, advertising and public relations activities to promote the Next Generation Supermarket or Next Generation Retails Business System are undertaken by the Franchisees and/or the Franchisor.

Following the opening of a Next Generation Supermarket or Next Generation Business System with commencement of retail sales operations, the individual RMOs are responsible for operating their businesses according to the terms and conditions of their Franchise Agreements. The Franchisor is responsible for overall management of the Next Generation Supermarket or the Next Generation Retail Business System Building and for facilitating the normal operation of the RMO Franchisees. The Franchisor is responsible for all maintenance and normal operating services (i.e., electricity, heat, garbage removal, parking facilities, snow removal etc.). The Franchisor also is responsible for enforcing the quality and other operational requirements of the RMO franchisees.

A preferred embodiment of the invention is a new retail system for grocery or supermarket enterprises. The Next Generation Supermarket of the invention can develop a distinct brand that will provide a competitive advantage that may conveniently be described as a Culture of Legendary Customer Service in a village-market-like or main-street-like environment. The “Store within a Store” concept is leasing agreements whereby the success of the each individual store operates independently of their common Landlord lessor. The Next Generation Supermarket goes beyond the “Store within a Store” concept. The Next Generation Supermarket system is a collection of strategically positioned retail-merchants ( RMOs) that operate independently under separate franchise agreements, but most importantly they operate with great interdependency. Such interdependency is a reflection of their complimentary products and/or services in conformance with their individual franchise agreement requiring standardized retail criteria. The franchise agreements of the RMOs define and require the maintenance of certain retail standards that are designed to provide a standard of excellence (i.e., Legendary Customer Service).

The Next Generation Supermarket proposes to supercede the traditional supermarket business model by making a Strategic Business Shift, thereby transforming it into a Retail-System, where the interests of the whole-system are equal to the interests of each individual Retail-Merchant participating in the Retail-System. The Strategic Business Shift occurs when the business focuses on generating profits from Real Estate Revenues and Gross Sales Revenues, then provides the financing necessary to deliver the competitive advantage of a Culture of Legendary Customer Service. The competitive advantage of a Legendary Customer Service Culture comes from the management authority of the Franchisor given in the franchise agreements to enforce common business principles and practices necessary to create a Culture of Legendary Service. This is in contrast to conventional supermarket operation where there is considerable reliance on various “buy” arrangements (i.e., Programs such as slotting fees, program allowances/BOGOs, and advertising fees).

Although the present invention describes in detail certain embodiments, it is understood that variations and modifications exist known to those skilled in the art that are within the invention. Accordingly, the present invention is intended to encompass all such alternatives, modifications and variations that are within the scope of the invention as set for in the following claims.

What is claimed is:

1. A retail shopping system comprising:
a franchisor;
at least two distinct-class retail merchant operator member franchisees selected from the group consisting of: retail merchant operators of perishable goods, retail merchant operators of non-perishable goods, and retail merchant operators of services trades; wherein said franchiser and said franchisees are co-located in a common structure.

2. The retail shopping system of claim 1, wherein said retail shopping system is a supermarket.

3. The retail shopping system of claim 1, wherein said retail merchant operator member franchisees are selected from the group consisting of: a fresh produce grocery member; a bakery member; a meat/butcher member; a fish & shellfish member; a dairy member; a non-perishable grocery member; an alcoholic beverage member; a food service member; a food specialties member; a service trades member; a florist member; a health and beauty aid member; a food catering member; a prepared food service member; an office supply outlet member; a drugstore member; a clothing store member; a sports specialties member; a hardware member; a drycleaner member; a bookseller member; a card seller member; an electronics member; a home furnishings member; an art gallery member; a photography member; a music member; a toys and hobbies member; a shoe member; a restaurant member; a fast food member; a tailor member; an eyeglass member; a dentist member; a physician member; a chiropractor member; a lawyer member; a market research member; an accountant member; a bank member; a plumbing supply member; a pawnshop member; a tattoo parlor member; an auto parts supply member; a therapeutic massage member; a health club member; a post office member; a building supply member; a plumber member; an electrician member; a garden supply and equipment member; a podiatrist member; a food specialties member and any combinations thereof.

4. The retail shopping system of claim 3, wherein said clothing store member is selected form the group of: men's fashions; women's fashions; and children's fashions, and any combinations thereof

5. The retail shopping system of claim 3, wherein said food specialties member is selected from the group of: a coffee member; a pretzel member; an ice cream member; a yogurt member; a cookie member, and any combinations thereof.

6. The retail shopping system of claim 3, wherein said shoe member is selected from the group of: men's shoes member, women's shoes member; children's shoes member; and any combinations thereof.

7. The retail shopping system of claim 3, wherein said service trades member is selected from the group of: shoe repair member; portrait studio member; jewelry repair member; bank member; optician member; travel bureau member; custom decorating member, and any combinations thereof.

8. The retail shopping system of claim 3, wherein said food service member is selected from the group of: a delicatessen member; a donut and bagel member; an ice cream and yogurt member; a Mexican, Japanese or other ethnic fast-food member; a sub and sandwich member; a non-alcoholic beverage member; and any combinations thereof.

9. The retail shopping system of claim 1, wherein said Franchisor provides property rights to said Franchisee selected from the group of: patents; trademarks; copyrights; branding; know-how; trade secrets, and leases and any combinations thereof.

10. The retail shopping system of claim 1, wherein said Franchisor provides at least one of the services selected from the group of: advertising, legendary customer service standards training, operational & ready for business standards training, equipment standards training, front-end Operations, RMO financial projections and sales goals services, merchant member business services, business support programs, internet data bases and marketing services, banking services, payroll services, employee health and medical benefits services, Next Generation supermarket training services, and Next Generation market branding services.

11. A method for providing a retail shopping system comprising;
selecting or constructing a retail building;
designing and constructing or modifying said retail building to accommodate a plurality of retail merchant operator franchisees and a franchisor;
selecting at least two distinct-class retail merchant operators;
forming a franchise arrangement between said retail merchant operators and said franchisor; and
entering retail shopping activities.

12. The method of claim 11, wherein said retail merchant operators are selected from the group consisting of: retail merchant operators of perishable goods, retail merchant operators of non-perishable goods, and retail merchant operators of services trades, and any combinations thereof.

13. The method of claim 11, wherein said retail merchant operators are selected from the group consisting of: a fresh produce grocery member; a bakery member; a meat/butcher member; a fish & shellfish member; a dairy member; a non-perishable grocery member; an alcoholic beverage member; a food service member; a food specialties member; a service trades member; a florist member; a health and beauty aid member; a food catering member; a prepared food service member; an office supply outlet member; a drugstore member; a clothing store member; a sports specialties member; a hardware member; a drycleaner member; a bookseller member; a card seller member; an electronics member; a home furnishings member; an art gallery member; a photography member; a music member; a toys and hobbies member; a shoe member; a restaurant member; a fast food member; a tailor member; an eyeglass member; a dentist member; a physician member; a chiropractor member; a lawyer member; a market research member; an accountant member; a bank member; a plumbing supply member; a pawnshop member; a tattoo parlor member; an auto parts supply member; a therapeutic massage member; a health club member; a post office member; a building supply member; a plumber member; an electrician member; a garden supply and equipment member; a podiatrist member; a food specialties member and any combinations thereof.

14. The method of claim 11, wherein said clothing store member is selected form the group of: men's fashions; women's fashions; and children's fashions, and any combinations thereof

15. The method of claim 11, wherein said food specialties member is selected from the group of: a coffee member; a pretzel member; an ice cream member; a yogurt member; a cookie member, and any combinations thereof.

16. The method of claim 11, wherein said shoe member is selected from the group of: men's shoes member, women's shoes member; children's shoes member; and any combinations thereof.

17. The method of claim 11, wherein said service trades member is selected from the group of: shoe repair member; portrait studio member; jewelry repair member; bank member; optician member; travel bureau member; custom decorating member, and any combinations thereof.

18. The method of claim 11, wherein said food service member is selected from the group of: a delicatessen member; a donut and bagel member; an ice cream and yogurt member; a Mexican, Japanese or other ethnic fast-food member; a sub and sandwich member; a non-alcoholic beverage member; and any combinations thereof.

19. The method of claim 11, wherein said Franchisor is providing property rights and to said Franchisee selected from the group of: patents; trademarks; copyrights; branding; know-how; trade secrets, and leases and any combinations thereof.

20. The method of claim 11, wherein said Franchisor is providing at least one of the services selected from the group of: advertising, legendary customer service standards training, operational & ready for business standards training, equipment standards training, front-end Operations, RMO financial projections and sales goals services, merchant member business services, business support programs, internet data bases and marketing services, banking services, payroll services, employee health and medical benefits services, Next Generation supermarket training services, and Next Generation market branding services.
